(19) United States
(12) Patent Application Publication
(10) Pub. No.: US 2013/0286641 A1
(43) Pub. Date: Oct. 31, 2013

(54) LANTERN WITH INTEGRATED CLAMP HANDLE

(71) Applicant: BLACKBEAM LLC, New York, NY (US)

(72) Inventors: Bruce ANCONA, New York, NY (US); Louis F. HENRY, Scarsdale, NY (US); Chris MELLEN, New York, NY (US)

(73) Assignee: BLACKBEAM LLC, New York, NY (US)

(21) Appl. No.: 13/873,957

(22) Filed: Apr. 30, 2013

Related U.S. Application Data
(60) Provisional application No. 61/640,359, filed on Apr. 30, 2012.

(51) Int. Cl. F21V 21/00

(52) U.S. Cl. CPC F21L 15/08
USPC 362/191

(57) ABSTRACT

A lantern having a handle with a clamp integrated therein, so that the lantern can be affixed to an object for hands free mode, or used portably. A battery compartment can be disposed within one of the clamp arms.

### CROSS-REFERENCE TO RELATED APPLICATIONS

The present disclosure claims priority to U.S. Provisional Patent Application No. 61/640,359, filed on Apr. 30, 2012, which is herein incorporated by reference.

### BACKGROUND OF THE DISCLOSURE

1. Field of the Disclosure

The present disclosure relates to lanterns having handles that have a clamp integrated therein.

2. Background

There is a significant need among users of lanterns to have some sort of “hands-free” capability and flexibility in mounting options. This is so the user can have both hands available to work on a task while the lantern illuminates a work space, or to take advantage of different kinds of mounting surfaces when, for example, the lantern is used in recreational or outdoor environments. Currently available lanterns are flat-bottomed devices that cannot be affixed to another object for mounting, and thus require a relatively flat surface to be steady.

Accordingly, there is a need for a lantern that can provide hands-free operation for a user, while simultaneously providing a portable capability.

### SUMMARY OF THE DISCLOSURE

The present disclosure overcomes these and other disadvantages of the lanterns of the prior art by providing a novel illumination device, such as a lantern, with a handle having an integrated clamp that can be affixed to an object. This allows the lantern to be used in hands-free mode, where it is affixed to an object, or to stand on its own. It can also be used in a portable mode, since the handle having the clamp integrated therein is ergonomically designed to be easily gripped and manipulated.

### BRIEF DESCRIPTION OF THE DRAWINGS

FIG. 1 is a front, perspective view of the lantern of the present disclosure.

FIG. 2 is a side, perspective view of the lantern of FIG. 1.

FIG. 3 shows the lantern of FIG. 1 affixed to an object.

### DETAILED DESCRIPTION OF THE DISCLOSURE

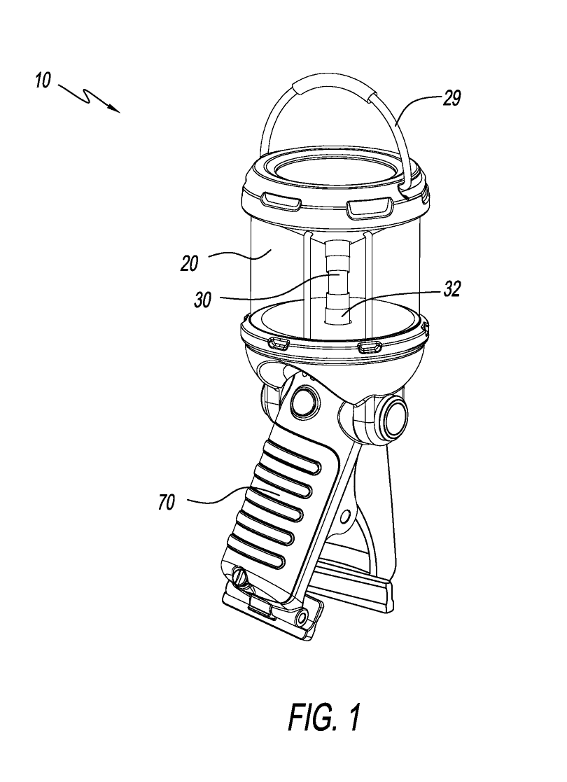

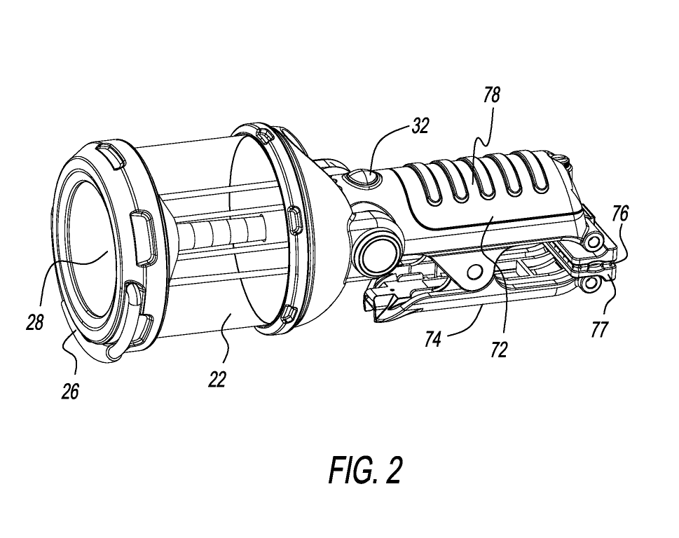

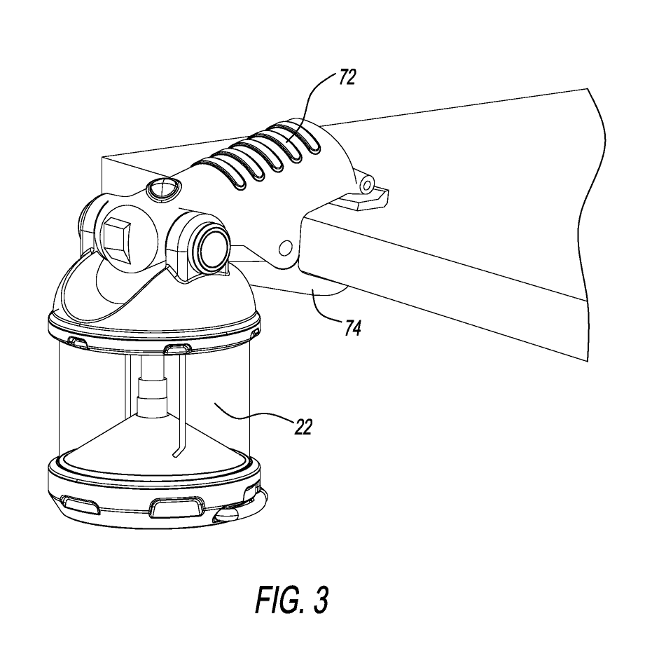

Referring to FIGS. 1-3, lantern 10 of the present disclosure is shown. Lantern 10 has a head 20 and a handle 70. Handle 70 further comprises a main arm 72 and a clamp arm 74, which are mounted to each other in such a way as to be biased in a closed position, as shown. Main arm 72 and clamp arm 74 can be gripped and squeezed together by a user, such that a clamp 76, defined by an end of main arm 72 and an end of clamp arm 74, opens, and can be attached to a fixed object as shown in FIG. 3. When clamp 76 is in its closed position and not affixed to an object or mounting surface (FIG. 2), main arm 72 and clamp arm 74 can be easily and comfortably held by a user, rendering lantern 10 portable. Main arm 72 and clamp arm 74 can also be set in an open position, so that lantern 10 can stand on its own (FIG. 1).

The present disclosure thus provides a lantern 10 that a user can use in hands-free operation by connecting it to an object. This is a marked difference from lanterns of the prior art, which typically comprise flat-bottomed bodies, that can only sit on a flat surface. Lantern 10 can take advantage of many different kinds of mounting surfaces such as edges of tables or other flat surfaces, poles, piping, branches of trees, articles of clothing or backpacks, and the like.

As used in the present disclosure, the term “lantern” signifies a lighting device that has a casing surrounding and protecting a light source. The casing is transparent or translucent in at least a portion thereof, to allow light transmitted by the light source to pass through the casing. Light can be projected out in at least two directions, namely along longitudinal (i.e., from the top of head 20) or radial (i.e., from the sides of head 20) axes.

Critically, since head 20 can pivot with respect to handle 70 (discussed in greater detail below), lantern 10 provides three-hundred-sixty-degree projected light no matter whether it is in a hanging, portable, or standing upright orientation. Furthermore, no currently available lanterns provide a plurality of carrying methods in addition to the advantages provided by clamp 76, namely to attach to many types of objects. For example, handle 70, with clamp 76, allows a hiker to clamp to a backpack when transporting lantern 10, versus a swinging lantern on a carrying handle.

Even with this functionality, lantern 10 remains portable for the user. Main arm 72 and clamp arm 74 can form a substantially cylindrical body for handle 70. This ergonomic design allows a user to comfortably and easily manipulate lantern 10.

For ease of describing lantern 10, the words “front,” “back,” “top,” and “bottom” reference the depiction shown in of FIG. 1, with lantern 10 standing upright, and with main arm 72 in front of clamp arm 74. These directional terms are used only for describing lantern 10, and are not meant to limit the interpretation of the features discussed below.

As previously discussed, main arm 72 and clamp arm 74 are biased into a closed position. A spring, actuator, or other device (not shown) can be placed between main arm 72 and clamp arm 74, to create tension between main arm 72 and clamp arm 74 and effect the bias. Main arm 72, clamp arm 74, and the spring device can be connected to each other with a pivot pin that travels through corresponding holes in main arm 72, clamp arm 74, the spring device, and spacers or covers that can be used to stabilize the spring device.

In one embodiment, the spring device is a torsion spring. The present disclosure, however, contemplates any devices that can create tension between main arm 72 and clamp arm 74, such as tension springs, extension springs, compression springs, integral plastic springs, wire or coil springs, and flat springs. These devices can be positioned around the axis of rotation of clamp arm 74, or in another location.

Head 20 has casing 22. In the shown embodiment, casing 22 has a substantially cylindrical profile, and is transparent or translucent. Casing 22 surrounds and protects light source 30. Thus, when batteries or another power source are placed in electrical communication with light source 30, light is transmitted from source 30 and out through casing 22, laterally to a main longitudinal axis of lantern 10. Head 20 also has top end 26. Top end 26 can have a light-transmitting portion 28 in the middle, so that light can also be transmitted through portion 28 and out through the top of lantern 10. Head 20 can also have a strap 29 connected to top end 26, with which the user can carry lantern 10.

Head 20 is connected to handle 70 so that it can rotate about a horizontal axis passing through the top of handle 70. This allows a user of lantern 10 to move head 20 to a suitable position when clamp 76 is affixed to an object, as shown in FIG. 3. As previously discussed, this is another highly advantageous feature of lantern 10 not seen in the prior art. Not only can lantern 10 be affixed to an object, but the user has the flexibility to adjust the angle of head 20 to provide maximum and optimal lighting. Other lanterns do not have the option to adjust the angle of the head or light with respect to the lantern body.

There can be discrete stops for head 20 along the arc of rotation, for example at perfectly horizontal or right angle positions with respect to handle 70. Head 20 can also be configured to be placed at any angle along the arc. There can be a suitable amount of friction between head 20 and handle 70 to ensure that head 20 stays in place when adjusted by the user. Head 20 and handle 70 can be connected to each other with a pivot rod that has button releases. Head 20 will remain in a substantially rigid position until the user depresses the button releases. The user can then move head 20 into the desired location.

In the shown embodiment, light source 30 is a single light at the bottom of head 20. When connected to the battery power source, light source 30 transmits light that passes through a tube 32, which scatters the light. In other embodiments, different types of light sources can be used that project light three-hundred-sixty-degrees and use conical reflectors to maximize the light output. There can also be a second light source (not shown), used in with its own reflector, to efficiently project light out of top end 26 of head 20.

Light source 30 can be one light or a plurality of lights operating on the same circuit in communication with the batteries powering lantern 10. Alternatively, light source 30 can be a plurality of lights operating on at least two separate circuits. In the latter embodiment, one circuit can engage a light to transmit out the side of lantern 10, and another circuit can engage a light to transmit light through light-transmitting portion 28 of top end 26. This effect can also be accomplished with one light source, and mechanisms that allow switching between the two. Light source 30 can be a light-emitting diode (LED).

A button membrane 32 can be connected to main arm 72, for example with a friction or snap fit. Through button membrane 32, the user can selectively place the lighting circuits described above in electrical communication with batteries (not shown) located in compartment 78 of main arm 72. Through button membrane 32, the user can select between a state in which all lights are off, all lights are on, or where selected lights are on while others remain off.

Lantern 10 may also have one or more opaque obstructions (not shown) that can block portions of casing 22. These can be useful in situations where the user only wishes light to pass through selected areas of casing 22. The obstructions can have reflectors on an interior portion thereof, to direct light in the opposite direction. The obstructions can be removable attachments the user removably connects to the exterior side of casing 22. The obstructions can also be curtains that drop down from top end 26, or are pulled up from the bottom end of casing 22 adjacent to handle 70.

In the shown embodiment, batteries are located within main arm 72. However, the present disclosure contemplates storing batteries within main arm 72, clamp arm 74, within head 20, or any combination thereof. Main arm 72 and/or clamp arm 74 can have overmolds thereon, to make handle 70 easier to grip.

Clamp arm 74 can also have a latch (not shown) at a top end thereof. The latch can have a front end that, when pushed in a forward direction by a user, engages a cavity in main arm 72. When the latch engages the cavity in this manner, clamp 76 remains in the open position, and lantern 10 can be placed in a standalone position on a surface, as shown in FIG. 1. This provides yet another mode of operation for lantern 10, in addition to those described above. The present disclosure also contemplates other methods for keeping clamp 76 in the open position. Clamp 76 can have feet 77 at the bottom thereof, to assist lantern 10 with standing on end as shown.

Any of the above described components can be made of materials such as acrylonitrile butadiene styrene (ABS), nylon, or other plastics, or can be made of cast or stamped metal.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated for carrying out this disclosure, but that the disclosure will include all embodiments falling within the scope of the claims.

What is claimed is:

1. A lantern, comprising:
a head, said head comprising a light source and a casing surrounding said light source; and
a clamp having one end rotatably connected to said head, and an opposite end having a gripping portion.

2. The lantern of claim 1, wherein said clamp has a first arm, and a second arm pivotably connected to said first arm.

3. The lantern of claim 2, wherein said first arm and said second arm are bias mounted to each other, so that said clamp is inclined toward a closed position.

4. The lantern of claim 3, wherein said first arm and said second arm are biased together with a spring.

5. The lantern of claim 2, wherein said first arm has a battery compartment disposed therein.

6. The lantern of claim 1, wherein said casing is at least partially transparent, so that said light source may transmit light therethrough.

7. The lantern of claim 1, wherein said head further comprises:
an outer end comprising a light-transmitting portion;
a clamp connection end; and
wherein said clamp connection end is rotatably connected to said clamp, and said casing is between said outer end and said clamp connection end.

8. The lantern of claim 7, wherein said transparent portion is aligned so that said light source may transmit light therethrough.

9. The lantern of claim 2, wherein said second arm has a latch disposed thereon, wherein said latch connects an end of said second arm opposite said gripping portion to said first arm, so that said clamp is in an open position.

10. The lantern of claim 3, wherein said clamp has a substantially cylindrical shape when in said closed position.

11. The lantern of claim 2, further comprising a battery compartment in at least one of said first clamp arm, said second clamp arm, and said head.

12. The lantern of claim 2, further comprising a battery compartment within at least one of said first arm and said second arm.

13. The lantern of claim 1, further comprising an opaque obstruction connected to said casing, wherein said obstruction covers are least a portion of said casing.

14. The lantern of claim 7, wherein said light-transmitting portion is transparent.

15. The lantern of claim 2, wherein said clamp has a hollow interior between said first arm and said second arm.

16. A lantern, comprising:
a head, said head comprising a casing and a light source within said casing; and
a handle comprising a clamp integrally formed therein,
wherein said clamp comprises a first end rotatably connected to said head, and a second end opposite said first end, and
wherein said clamp comprises a first arm and a second arm rotatably connected to said first arm, and
wherein said first arm and said second arm form a gripping portion at said second end.

17. The lantern of claim 16, wherein said first arm and said second arm are bias mounted to each other, so that said clamp is inclined toward a closed position.
